(19) United States
(12) Patent Application Publication
(10) Pub. No.: US 2024/0099340 A1
(43) Pub. Date: Mar. 28, 2024

(54) COOKED RICE QUALITY IMPROVER, COOKED RICE USING THE SAME AND METHOD FOR MANUFACTURING THE COOKED RICE

(71) Applicant: KIYOTA SANGYO CO., LTD., Nagoya-shi (JP)

(72) Inventors: Hiroaki SATO, Nagoya-shi (JP); Runa ISHIKAWA, Nagoya-shi (JP)

(73) Assignee: KIYOTA SANGYO CO., LTD., Nagoya-shi (JP)

(21) Appl. No.: 18/368,245

(22) Filed: Sep. 14, 2023

(30) Foreign Application Priority Data
Sep. 22, 2022 (JP) 2022-151455

(51) Int. Cl. A23L 7/196; A23L 29/00

(52) U.S. Cl. CPC A23L 7/1965; A23L 29/06

(57) ABSTRACT

A cooked rice quality improver composition configured to improve the texture of cooked rice and extended texture stability so as to meet demands in the food industry, cooked rice prepared using such device, and a method for producing the cooked rice.

The cooked rice quality improver contains an α-amylase and/or a glucosyltransferase, and a pectinase. The pectinase may be an enzyme that is substantially free of a polygalacturonase activity and a pectin lyase activity, and that has a pectin methylesterase activity. In addition, the pectinase may be an enzyme having a pectintranseliminase activity.

### TECHNICAL FIELD

The present invention relates to a cooked rice quality improver composition configured to improve qualities of rice such as texture and texture stability during cooking of rice, a cooked rice using the same and a method for manufacturing the cooked rice.

### BACKGROUND OF THE INVENTION

Cooked rice, due to its starch retrogradation over time, can be drier and harder, resulting in deteriorated texture. The cooked rice, kept even at normal temperature, will exhibit a dry texture 24 hours after cooking, and subsequently be harder and deformed. Refrigeration storage also facilitates this quality deterioration and brings about a harder and drier texture. It is to be noted that cooked rice is actually served as plain rice or seasoned rice such as pilaf and fried rice, each having a distinct required texture. Accordingly, such a distinct texture needs its corresponding cooked rice manufacturing technique. However, it has extremely been hard to stably maintain a required texture over time against its inherent retrogradation.

A typical countermeasure taken in the food industry is to more noticeably inhibit the dry state on the surface of cooked rice and retrogradation, increase the yield of rice products, and raise the amount of water added for cooking rice in view of economic efficiency. This approach provides certain effects on the dry state on the surface of cooked rice over time and changes in the texture due to retrogradation. Nevertheless, rice grains cannot sufficiently absorb increased water added for cooking rice, which unfortunately makes the surface of just-cooked rice sticky. As another conventional problem, it is hard to properly shape just-cooked soft and sticky rice into rice balls or sushi.

Increases in water added for cooking rice deteriorate the convection in a large rice cooker for professional use due to heavier water weight, resulting in unevenly cooked rice qualities at the upper, middle and lower parts in the cooker. A cooked rice at the lower part of the cooker, in particularly, is significantly crushed. The resultant unevenly cooked rice quality, depending on the part in the cooker, fails to achieve stable manufacturing of cooked rice for professional use.

It is to be noted that a method for maintaining a favorable texture of a cooked rice over time is to use in combination pH adjusters, rice cooking oils, starch-modifying enzymes (e.g., α-amylase), and so on. Its associated problems, however, include insufficient texture stability, unusual taste and mandatory labeling for food additives. It is to be noted that a method using starch-modifying enzymes, despite numerous discussions and certain positive evaluations, cannot satisfactorily overcome retrogradation during refrigeration storage.

Inventors of the present invention propose in the following Patent Document 1 a food performance improver for foods using ingredients containing a wide variety of starches, and found that the use of certain enzymes can improve the texture of a cooked rice over time.

### PRIOR ART DOCUMENT

### Patent Document

Patent Document 1: Japanese Patent Laid-Open No. 2022-047051 A

### SUMMARY OF INVENTION

### Technical Problem

The above-described Patent Document 1, however, demonstrates improvements in the texture of a cooked rice over time. In reality, cooked rice manufactured in the food industry preferably has a more extended texture stability. It is to be noted that since currently marketed Japanese rice is available not only in Japan, but also in Southeast Asian and Western countries, they are required to endure much longer transport, depending on countries and regions for shipment. The above-described conventional technologies have numerous problems with regard to the texture of a cooked rice and texture stability in order to, for example, improve the texture and overcome retrogradation, inhibit sticky surface of just-cooked rice, improve shaping of cooked rice into rice balls or sushi, and further improve the convection in large rice cookers for professional use.

Thus, the present invention was made in view of the situation to solve the problems, and has an object to provide a cooked rice quality improver composition configured to improve the texture and extended texture stability of cooked rice so as to meet demands in the food industry, a cooked rice using the same, and a method for manufacturing the cooked rice.

### Solution to Problem

To solve the aforementioned problem, inventors of the present invention have carried out an extended investigation to find that the texture of a cooked rice and extended texture stability can be improved by focusing on synergetic effects of multiple types of enzymes. Based on that technique, embodiments of the present invention were accomplished.

Specifically, a cooked rice quality improver composition (or, interchangeably, cooked rice quality improver) according to the present invention, includes, according to description in claim 1,
an α-amylase and/or a glucosyltransferase, and a pectinase.

Moreover, the present invention is, according to description in claim 2, the cooked rice quality improver composition according to claim 1, characterized in that
the α-amylase is an endo-type enzyme.

Further, the present invention is, according to description in claim 3, the cooked rice quality improver according to claim 1, characterized in that
the glucosyltransferase has a 4-α-glucanotransferase activity.

Moreover, the present invention is, according to description in claim 4, the cooked rice quality improver according to any one of claims 1 to 3, characterized in that
the pectinase has a pectin methylesterase activity.

Moreover, the present invention is, according to description in claim 5, the cooked rice quality improver according to claim 4, characterized in that
the pectinase is substantially free of a polygalacturonase activity and a pectin lyase activity.

Moreover, the present invention is, according to description in claim 6, the cooked rice quality improver according to any one of claims 1 to 3, characterized in that
the pectinase has a pectintranseliminase activity.

Also, a cooked rice according to the present invention is manufactured, according to description in claim 7,
using the cooked rice quality improver according to claim 5.

Also, a cooked rice according to the present invention is manufactured, according to description in claim 8,
using the cooked rice quality improver according to claim 6.

Moreover, a method for manufacturing a cooked rice according to the present invention includes, according to description in claim 9,
allowing an α-amylase and/or a glucosyltransferase to act on a rice in combination with a pectinase in rice processing steps, including immersing, cooking, and steaming, to manufacture a cooked rice. Or, in other words, interacting a composition, which includes an α-amylase and/or a glucosyltransferase in combination with a pectinase, with raw rice during rice processing steps, the processing steps including one or more of immersing, cooking, and steaming.

Also, the present invention, according to claim 10, is the method for manufacturing a cooked rice according to claim 9, characterized in that
the α-amylase is an endo-type enzyme.

Moreover, the present invention, according to claim 11, is the method for manufacturing a cooked rice according to claim 9, characterized in that
the glucosyltransferase has a 4-α-glucanotransferase activity.

Also, the present invention, according to claim 12, is the method for manufacturing a cooked rice according to any one of claims 9 to 11, characterized in that
the pectinase has a pectin methylesterase activity.

Moreover, the present invention, according to claim 13, is the method for manufacturing a cooked rice according to claim 12, characterized in that
the pectinase is substantially free of a polygalacturonase activity and a pectin lyase activity.

Also, the present invention, according to claim 14, is the method for manufacturing a cooked rice according to any one of claims 9 to 11, characterized in that
the pectinase has a pectintranseliminase activity.

### Advantageous Effects of Invention

According to the above configuration, a cooked rice quality improver according to the present invention contains an α-amylase and/or a glucosyltransferase, and a pectinase. The α-amylase is preferably an endo-type enzyme. The glucosyltransferase preferably has a 4-α-glucanotransferase activity. The pectinase preferably has a pectin methylesterase activity.

It is to be noted that the pectinase having the pectin methylesterase activity may substantially be free of a polygalacturonase activity and a pectin lyase activity. In addition, the pectinase may have a pectintranseliminase activity, in place of a pectin methylesterase activity. According to the present invention, there can be provided a cooked rice quality improver capable of improving the texture of a cooked rice and extended texture stability so as to meet demands in the food industry by synergetic effects of each of the enzymes.

Moreover, according to the above configuration, a cooked rice according to the present invention is manufactured using the above-described cooked rice quality improver. According to the above configuration, a method for manufacturing a cooked rice includes allowing an α-amylase and/or a glucosyltransferase to act on a rice in combination with a pectinase in rice processing steps, including immersing, cooking, and steaming, to manufacture a cooked rice. The α-amylase is preferably an endo-type enzyme. The glucosyltransferase preferably has a 4-α-glucanotransferase activity. The pectinase preferably has a pectin methylesterase activity.

It is to be noted that the pectinase having the pectin methylesterase activity may substantially be free of a polygalacturonase activity and a pectin lyase activity. In addition, the pectinase may have a pectintranseliminase activity, in place of a pectin methylesterase activity. According to the present invention, there can be provided a cooked rice capable of improving the texture of a cooked rice and extended texture stability which can meet demands in the food industry and a method for manufacturing the same.

### BRIEF DESCRIPTION OF THE DRAWINGS

FIG. 1 is a photo showing the state of the surface of a just-cooked rice (in the form of crab holes) in Example 1.

### DETAILED DESCRIPTION

The present invention will now be described hereinafter in detail. In the present invention, cooked rice refers to not only plain rice, but also steamed glutinous rice (“OKOWA” in Japanese), just-cooked and prepared vinegared rice, fried rice, shaped rice balls, seasoned rice, frozen foods thereof, and all other processed rice products including instant foods for extended storage such as aseptic rice. The types of rice cooked using a cooked rice quality improver according to the present invention are not particularly restricted, and they may be any of japonica rice, indica rice and javanica rice. In addition, the rice polishing degree is not particularly restricted, and combinations and amounts of enzymes used may be selected depending on the rice polishing degree.

The cooked rice quality improver according to the present invention includes at least 2 types of enzymes used in combination, having distinct effects. A first enzyme used is any of an α-amylase, a glucosyltransferase, or an α-amylase and a glucosyltransferase combined. A second enzyme used is a pectinase. It is to be noted that in addition to these first and second enzymes used in combination, other enzymes having additional effects may further be used as required.

An α-amylase used in the present invention may be in the state of crude enzyme, and may also be an amylase as a conjugated enzyme. Also, the origin of the α-amylase used in the present invention is not particularly restricted. Illustrative example of the origin of the α-amylase includes Aspergillus oryzae, Aspergillus niger, Bacillus amyloliquefaciens, and Bacillus licheniformis.

It is to be noted that the α-amylase used in the present invention is preferably an endo-type enzyme. Such an endo-type α-amylase irregularly hydrolyzes a α-1,4-glucoside bond of a starch or a glycogen and generates a low-molecular soluble dextrin.

A glucosyltransferase used in the present invention is a transfer enzyme of glucosyl group which catalyzes the transfer of a glucose residue. There are many types of enzymes classified as glucosyltransferase. In the present invention, among other things, an α-glucanotransferase is a preferably used. Illustrative example of the α-glucanotransferase includes a 4-α-glucanotransferase and a 6-α-glucanotransferase.

In the present invention, a 4-α-glucanotransferase is particularly preferably used. The 4-α-glucanotransferase catalyzes a chemical reaction which transfers a moiety of a 1,4-α-glucan to another moiety of a hydrocarbon such as a glucose or a 1,4-α-glucan. It is to be noted that in the present invention, the 4-α-glucanotransferase modifies a starch composed of rice grains as a substrate. Specifically, the 4-α-glucanotransferase has a mechanism for modifying an amylose or an amylopectin contained in a starch as a substrate, extending a molecular chain and allowing the chain to branch out. Moreover, in the present invention, the origin of the 4-α-glucanotransferase is not particularly restricted, but the enzyme used is preferably excellence, particularly in heat resistance.

A pectinase used in the present invention may be in the state of crude enzyme, or a conjugated enzyme having multiple activities, including a polygalacturonase, a pectin lyase, a pectinesterase, a pectin methylesterase, and a pectintranseliminase. The origin of the pectinase used in the present invention is not particularly restricted. Illustrative example of the origin of the pectinase includes Aspergillus kawachii, Aspergillus usamii mutant shirousamii, Aspergillus oryzae, Aspergillus sojae, Aspergillus tamarii, Aspergillus niger, Aspergillus awamori, Aspergillus pulverulentus, Aspergillus aculeatus, Trichoderma viride, and Rhizopus oryzae.

It is to be noted that the pectinase used in the present invention preferably has a pectin methylesterase activity. In this regard, the pectinase may be an enzyme having a strong pectin methylesterase activity, or an enzyme fractionated as a pectin methylesterase. Further, the pectinase having a pectin methylesterase activity is substantially free of a polygalacturonase activity and a pectin lyase activity for decomposing a pectin chain, and preferably has a pectin methylesterase activity.

Herein, the pectin methylesterase activity refers to an effect of a pectin as a substrate to demethylate a methoxyl group and form a carboxyl group without decomposing a pectin molecular chain. Thus, in the present invention, the pectin methylesterase activity has an effect of modifying a pectin contained together with a starch to a pectin having a high low-methyl ester content (i.e., high galacturonic acid content).

Accordingly, inventors of the present invention conceived the idea of the effect of a pectin methylesterase activity as follows. The pectin methylesterase activity allows many pectin layers present on the surface of rice grains to increase negative charges of a pectin coexisting with a starch, which makes the surface more hydrophilic. The resultant growing electrostatic repulsion can inhibit a hydrogen bond of an amylose and an amylopectin in a starch, particularly a hydrogen bond of amyloses. Thus, since the pectinase having a pectin methylesterase activity loosens the layers on the surface of rice grains, the effect of an α-amylase, a glucosyltransferase used in combination with a pectinase is enhanced.

In addition, the pectinase used in the present invention may have a pectintranseliminase activity, in place of a pectin methylesterase activity. It is to be noted that as required, the pectinase may have a pectintranseliminase activity together with a pectin methylesterase activity. It is to be noted that the pectinase having a pectintranseliminase activity may be in the state of crude enzyme, or a pectinase as a conjugated enzyme. In addition, the pectinase may be an enzyme fractionated as a pectintranseliminase.

The pectinase having a pectintranseliminase activity is a lyase capable of directly decomposing a pectic material as a single enzyme. Containing a pectintranseliminase as a single enzyme provides a reaction different from that using 2 types of conventionally-used hydrolases: enzymes of pectinesterase and pectinpolygalacturonase, which forms a mechanism of decomposing a pectic material. Specifically, a pectic material can directly be decomposed at a moiety of a methyl esterified galacturonic acid. Also, the moiety to be modified is different from that conventionally available. It is thus believed that the pectintranseliminase generates a reaction product different from the pectinpolygalacturonase and the pectin methylesterase, resulting in distinct changes in the texture.

In the present invention, it is confirmed that a pectinase having a pectintranseliminase activity, in combination with a glucosyltransferase having a 4-α-glucanotransferase activity in particular, can improve the extended texture over time. Accordingly, inventors of the present invention conceived the idea of the effect of a pectintranseliminase activity as follows. The effect of a pectintranseliminase activity decomposes a pectin chain on many pectin layers present on the surface of rice grains. The resultant decomposed pectin structure demonstrates numerous methyl esterified galacturonic acids present in a monomolecular and low-molecular form. The resultant increased water retention represses water desorption from rice, promotes the wet state by a glucosyltransferase, enhances the effect of the pectintranseliminase activity, and stably maintains an extended wet texture.

A method for manufacturing a cooked rice according to the present invention is to allow the above-described α-amylase and/or glucosyltransferase to act on a rice in combination with a pectinase. It is to be noted that these enzymes may be allowed to act on the rice simultaneously. Alternatively, the pectinase may be allowed to act on the rice, followed by the α-amylase and/or the glucosyltransferase, and vice versa.

These enzymes are effectively used in rice processing steps, including immersing, cooking, steaming, steam-cooking, boiling, and cooking in a frying pan in order to allow these enzymes to act on the rice. In addition, these processing steps may be combined to provide such an effect. For example, when water is added to rinsed rice before cooking, enzymes are added to the rice for immersion for a predetermined period of time. Thereafter, the rice may be cooked, while being immersed in water containing the enzymes.

Subsequently, a cooked rice using a cooked rice quality improver according to the present invention and a method for manufacturing the cooked rice will be described with reference to each of the following Examples in detail. It is to be noted that the present invention is not restricted to each of the following Examples, and not to types of specific cooked rice and each of the enzymes recited herein only.

An α-amylase used in each of the following Examples was an enzyme produced by Bacillus amyloliquefaciens. The α-amylase (hereinafter referred to as “α-A enzyme”) was an endo-type enzyme. The α-A enzyme has an optimum pH of 5.5 to 6.0 and an optimum temperature of 70° C., and an α-amylase activity (titer) was defined as an enzyme activity unit (α-AU) which decreases the color of a potato starch detected by iodine by 10% for one minute.

In each of the following Examples, a glucosyltransferase used was an enzyme produced by Aeribacillus pallidus. The glucosyltransferase was an enzyme having a 4-α-glucanotransferase activity (hereinafter referred to as “GTF enzyme”). The GTF enzyme has an optimum pH of 7.5 and an optimum temperature of 50° C., and a 4-α-glucanotransferase activity (titer) was defined as an enzyme activity unit (GTFU) which produces 1 μmol of glucose from a maltotetraose for one minute.

In each of the following Examples, two types of pectinases were used. A first pectinase was an enzyme, having a pectin methylesterase activity, produced by Aspergillus niger (hereinafter referred to as “PME enzyme”), which is substantially free of a polygalacturonase activity and a pectin lyase activity, and has a strong pectin methylesterase activity. The PME enzyme has an optimum pH of 4.5 and an optimum temperature of 50° C., and a pectin methylesterase activity (titer) was defined as an enzyme activity unit (PMEU) which produces 1 μmol of carboxyl group by decomposing a methyl ester of a pectin for one minute.

A second pectinase is an enzyme, having a pectintranseliminase activity, produced by Aspergillus japonicus (hereinafter referred to as “PTE enzyme”), which has a strong pectintranseliminase activity. The PTE enzyme has an optimum of pH 5.0 and an optimum temperature of 45° C. and a pectintranseliminase activity (titer) was defined as follows. First, a commercially available pectin reagent (NACALAI TESQUE, INC.; Product Code 26234-92) was used as a substrate, which was dissolved in a McIlvaine buffer (pH 5.5) to prepare a solution (substrate: 0.5 g/100 ml). The solution was subjected to centrifugal separation (3000 rpm, 10 minutes) to prepare its supernatant as a reaction liquid. The enzyme activity unit (PTEU) was defined as the enzyme content which increases the absorbance in a reaction liquid by 1.0 for 60 seconds in a reaction at 40° C. for 10 minutes.

It is to be noted that in the present invention, the amount of a cooked rice quality improver added (titer of each enzyme) is not particularly restricted. It is to be noted that an α-A enzyme may be 0.005 α-AU or more per g of rice, preferably 0.02 α-AU or more, and more preferably 0.04 α-AU or more. A GTF enzyme may be 0.0035 GTFU or more per g of rice, preferably 0.005 GTFU or more, and more preferably 0.01 GTFU or more. A PME enzyme may be 0.0015 PMEU or more per g of rice, preferably 0.008 PMEU or more, and more preferably 0.01 PMEU or more. A PTE enzyme may be 0.00005 PTEU or more per g of rice, preferably 0.0001 PTEU or more, and more preferably 0.0004 PTEU or more.

### Example 1

This Example 1 is directed to a cooked rice, using an α-A enzyme and a PME enzyme in combination. In cases where a rice is cooked using a gas rice cooker, the heating power, which is much stronger than an electric rice cooker, is unevenly distributed, e.g., very high at the bottom part of the cooker only in a certain direction. Thus, such a gas rice cooker is unfortunately characterized by poor convection in the cooker, resulting in unstable and uneven rice quality (texture), depending on the upper, middle and lower parts in the cooker. Further, this problem is much more pronounced to manufacture a cooking rice in large quantities, using large gas rice cookers provided in a factory production line. Therefore, the use of an α-A enzyme to remove stickiness on the surface of rice grains generated in the process of cooking rice is expected to provide effects of improving the convection in the cooker and allowing the rice grains at the upper, middle and lower parts of the cooker during cooking to stably mix.

In this Example 1, it is confirmed that an α-A enzyme is allowed to act on a rice to cook the rice in combination with a PME enzyme to allow the PME enzyme to significantly enhance the effect of the α-A enzyme. Inventors of the present invention believed that by loosening many pectin layers present on the surface of rice grains by the effect of the PME enzyme, the effect of the α-A enzyme can be enhanced. In addition, by using these enzymes in combination, each having even low rates to be added, the quality of the cooked rice can significantly be improved, resulting in highly commercially economic efficiencies. Further, the cooked rice was successfully provided with long-duration water retention and texture such as springy texture and softness.

### 1. Rice Cooking Operation

First, 450 g of raw rice (Aichi-no-kaori: a Japanese rice variety) was rinsed, and thereafter immersed in water such that the total weight of water and rice is 1,125 g and an amount of added water is 150%. A PME enzyme (0.01 PMEU per g of rice) and an α-A enzyme (0.04 α-AU per g of rice) were added to a sample thus prepared in Example 1. The compositions of samples in Comparative Examples 1-1 to 1-3 are as follows.
Comparative Example 1-1: none of the enzymes added,
Comparative Example 1-2: only PME enzyme added (0.01 PMEU per g of rice),
Comparative Example 1-3: only α-A enzyme added (0.04 α-AU per g of rice).

Thereafter, each of the samples was added to a rice to be cooked in a gas rice cooker with a cooking capacity of 5 cups of rice by normal operation. It is to be noted that in this Example 1, the α-A enzyme and the PME enzyme acted on a rice while cooking the rice from normal temperature to 100° C., particularly from normal temperature to approx. 85° C., after each of the enzymes was added.

### 2. Evaluation

In this Example 1, a just-cooked rice was evaluated both from the texture of a cooked rice (a sensory evaluation) and the convection in the cooker during cooking (a visual evaluation). In addition, variations over time were evaluated from the texture of a cooked rice (a sensory evaluation) 30 hours after normal-temperature storage.

First, the texture was evaluated in terms of 4 items: water retention feeling, springy texture, softness on the surface, and less stickiness on the surface by score according to the sensory evaluation. Specifically, 4 skilled evaluators determined the texture ranging from 0 point (unfavorable) to 5 points (favorable), and averaged the score.

Herein, the water retention feeling refers to the state of rice grains to hold water with the watery surface, showing the higher the score is, the more favorable and preferable the water retention feeling is. The springy texture refers to a glutinous, resilient texture on the teeth when chewing, showing the higher the score is, the more favorable and preferable the springy texture is. The softness on the surface refers to less resiliency on the teeth when starting to chew, showing the higher the score is, the more favorable and preferable the softness is. The less stickiness on the surface refers to smooth surface of rice grains with less stickiness, showing the higher the score is, the less stickiness on the surface is and the more favorable and preferable the particulate appearance is.

Meanwhile, the convection while cooking a rice in the cooker was evaluated by visually confirming the state of the surface of a cooked rice and counting the number of trails of the convection of rice grains (hereinafter referred to as “crab holes”). Specifically, the convection was evaluated as favorable with 20 or more crab holes in relation to the cross-sectional area of the cooker used in this Example 1 (surface area of cooked rice: 266 cm²).

First, a just-cooked rice was evaluated as Just-cooked Grade “A” when the score for 4 items of a sensory evaluation totaled 14 or more, and crab holes totaled 20 or more. Also, even if crab holes totaled less than 20, a just-cooked rice was evaluated as Just-cooked Grade “B” with the score for 4 items of a sensory evaluation totaling 14 or more. Further, a just-cooked rice was evaluated as Just-cooked Grade “C” when the score for 4 items of a sensory evaluation totaled 9 or more and less than 14, and otherwise as Just-cooked Grade “D”.

Meanwhile, variations over time were evaluated, according to a sensory evaluation only, as Variations-over-time Grade “A” when the score for 4 items of a sensory evaluation 30 hours after normal-temperature storage totaled 14 or more. Further, variations over time were evaluated as Variations-over-time Grade “B” when the score for 4 items of a sensory evaluation totaled 9 or more and less than 14, and otherwise as Variations-over-time Grade “C”.

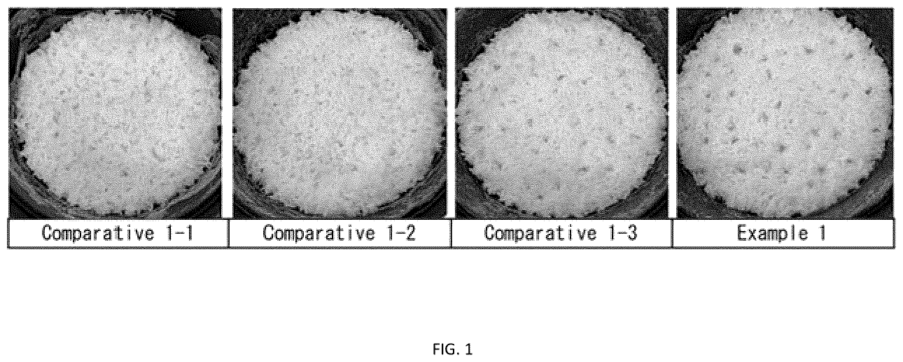

A comprehensive evaluation was given as Comprehensive-evaluation Grade “SA” with the most favorable state, having the Just-cooked Grade “A” and Variations-over-time Grade “A”. Table 1 shows evaluation results of a just-cooked rice, and Table 2 shows evaluation results of variations over time and comprehensive evaluations. FIG. 1 is a photo showing the state of the surface of a just-cooked rice (in the form of crab holes).

TABLE 1

| | | Comparative | | | Example |
|---|---|---|---|---|---|
| | | 1-1 | 1-2 | 1-3 | 1 |
| Tasting timing | | Just after cooking | | | |
| PMEU (U/g of rice) | | 0 | 0.01 | 0 | 0.01 |
| α-AU (U/g of rice) | | 0 | 0 | 0.04 | 0.04 |
| Immediate | Water | 2.0 | 3.0 | 1.0 | 3.0 |
| sensory | retention | | | | |
| evaluation | feeling | | | | |
| | Springy | 2.0 | 3.0 | 1.0 | 3.0 |
| | feeling | | | | |
| | Softness on | 2.0 | 2.5 | 2.5 | 4.0 |
| | the surface | | | | |
| | Less | 2.0 | 1.0 | 3.0 | 5.0 |
| | stickiness on | | | | |
| | the surface | | | | |
| | Total score | 8.0 | 9.5 | 7.5 | 15.0 |
| Convection | Number of | 5 | 0 | 22 | 31 |
| evaluation | crab holes | | | | |

| | | | | |
|---|---|---|---|---|
| Just-cooked Grade | C | B | C | A |

As shown in Table 1 and FIG. 1 showing an evaluation of a just-cooked rice, in relation to Comparative Example 1-1 (conventional type of cooked rice) where none of the enzymes was added, no crab holes were found in Comparative Example 1-2 where only a PME enzyme was added and the convection was not improved. However, in a sensory evaluation, the score in Comparative Example 1-2 was slightly higher than in Comparative Example 1-1, but the texture of the cooked rice was not improved, and the effect of the PME enzyme alone was insufficient. Meanwhile, in Comparative Example 1-3 where only an α-A enzyme was added, 22 crab holes were found to show an improvement in the convection. This improvement can be evaluated due to the effect of the α-A enzyme to decompose the stickiness on the surface of rice grains and stably mix the rice grains at the upper, middle and lower parts of the cooker. However, in a sensory evaluation, the results in Comparative Example 1-3 were substantially similar to those in Comparative Example 1-1, showing no improvement in the texture and an insufficient effect of the α-A enzyme alone.

In relation to these Comparative Examples, 31 crab holes were found in Example 1 where a PME enzyme and an α-A enzyme were used in combination, showing much more improvement in the convection than Comparative Example 1-3 where only an α-A enzyme was added. This improvement can be evaluated due to the effect of the PME enzyme to loosen pectin layers on the surface of rice grains and subsequently the effect of the α-A enzyme to be enhanced to stably mix the rice grains at the upper, middle and lower parts of the cooker. In the sensory evaluation in Example 1, the total score was 15, showing a significant improvement in the texture of the just-cooked rice. Consequently, in this Example 1, the rice was evaluated as Just-cooked Grade “A” from the results of the sensory evaluation and convection evaluation.

TABLE 2

| | | Comparative | | | Example |
|---|---|---|---|---|---|
| | | 1-1 | 1-2 | 1-3 | 1 |
| Tasting timing | | 30 hours after | | | |
| | | normal-temperature storage | | | |
| PMEU (U/g of rice) | | 0 | 0.01 | 0 | 0.01 |
| α-AU (U/g of rice) | | 0 | 0 | 0.04 | 0.04 |
| Sensory | Water | 1.0 | 2.0 | 1.0 | 2. 5 |
| evaluation | retention | | | | |
| over time | feeling | | | | |
| | Springy | 1.0 | 2.0 | 1.0 | 2. 5 |
| | feeling | | | | |
| | Softness on | 1.0 | 1.5 | 1.0 | 4.0 |
| | the surface | | | | |
| | Less | 4.0 | 2.5 | 3.0 | 5.0 |
| | stickiness on | | | | |
| | the surface | | | | |
| | Total score | 7.0 | 8.0 | 6.0 | 14.0 |
| Variations-over-time Grade | | C | C | C | A |
| Comprehensive | Just-cooked | C | B | C | A |
| evaluation | Grade | | | | |
| | Variations- | C | C | C | A |
| | over-time | | | | |
| | Grade | | | | |
| | Comprehensive | — | — | — | SA |
| | evaluation | | | | |

As shown in Table 2 showing the results of the sensory evaluation conducted 30 hours after normal-temperature storage of the cooked rice, the texture 30 hours after normal-temperature storage of the cooked rice was not favorable in Comparative Examples 1-1, 1-2, and 1-3. On the other hand, in the sensory evaluation in Example 1, the total score was 14 and the rice remained highly evaluated, showing much more improvement in the texture 30 hours after normal-temperature storage of the cooked rice than Comparative Example 1-1 (conventional type of cooked rice). Consequently, in this Example 1, the rice was evaluated as Variations-over-time Grade “A” from the results of the sensory evaluation conducted 30 hours after normal-temperature storage of the cooked rice.

The results in Tables 1 and 2 found that in this Example 1, the rice was evaluated as Comprehensive Evaluation “SA” from both Just-cooked Grade and Variations-over-time Grade. Thus, a synergetic effect of an α-A enzyme and a PME enzyme successfully significantly improved the performance of a just-cooked rice and a rice after normal-temperature storage.

### Example 2

This Example 2 is directed to a steamed glutinous rice, using a GTF enzyme and a PME enzyme in combination. In fact, the steamed glutinous rice requires glutinous particulate appearance. In order to modify an amylose and an amylopectin contained in a starch, an expected effect of a GTF enzyme is to extend a molecular chain, allow the chain to branch out, and provide a glutinous texture.

In this Example 2, it is confirmed that a GTF enzyme is allowed to act on a rice to cook the rice in a steamer in combination with a PME enzyme to allow the GTF enzyme to significantly enhance the effect of the PME enzyme. Inventors of the present invention believed that by loosening many pectin layers present on the surface of rice grains (glutinous rice, non-glutinous rice) by the effect of the PME enzyme, the effect of the GTF enzyme can be enhanced. In addition, by using these enzymes in combination, each having even low rates to be added, the quality of the steamed glutinous rice can significantly be improved, resulting in highly commercially economic efficiencies.

### 1. Rice Steaming Operation

First, 130 g of glutinous rice and 32.5 g of non-glutinous rice were rinsed, put into a bowl, and immersed in seasoning liquid (stock soy sauce, sake, salt, Mirin (low-alcohol cooking rice wine), water) in which each of the enzymes was dissolved for 4 hours to prepare a sample. A PME enzyme (0.01 PMEU per g of rice) and a GTF enzyme (0.01 GTFU per g of rice) were added to a sample thus prepared in Example 2. The compositions of samples in Comparative Examples 2-1 to 2-3 are as follows.
Comparative Example 2-1: none of the enzymes added,
Comparative Example 2-2: only PME enzyme added (0.01 PMEU per g of rice),
Comparative Example 2-3: only GTF enzyme added (0.01 GTFU per g of rice).

Each of the samples prepared was put into a sieve to keep a seasoning liquid. Thereafter, a rice was steamed in a steam convection oven as a steamer using each of the samples under general conditions (100° C., 30 minutes, humidity: 100%). During this steaming operation, 50 g of seasoning liquid was put on a steamed rice 10 minutes after steaming and another seasoning liquid was put on the rice 10 minutes later. The steamed rice was afterheated at 80° C. for 5 minutes. It is to be noted that in this Example 2, the GTF enzyme and the PME enzyme acted on a rice while steaming the rice from normal temperature to 100° C., particularly from normal temperature to approx. 80° C., after each of the enzymes was immersed in a seasoning liquid added.

### 2. Evaluation

In this Example 2, a just-steamed rice was evaluated from the texture of a steamed glutinous rice (sensory evaluation). In addition, variations over time were evaluated from the texture of a steamed glutinous rice (sensory evaluation) 30 hours after normal-temperature storage.

The texture was evaluated in terms of 3 items: water retention feeling, springy texture, and softness on the surface by score according to a sensory evaluation. Specifically, 4 skilled evaluators determined the texture ranging from 0 point (unfavorable) to 5 points (favorable), and averaged the score.

Herein, the water retention feeling refers to the state of rice grains to hold water with the watery surface, showing the higher the score is, the more favorable and preferable the water retention feeling is. The springy texture refers to a glutinous, resilient texture on the teeth when chewing, showing the higher the score is, the more favorable and preferable the springy texture is. The softness on the surface refers to less resiliency on the teeth when starting to chew, showing the higher the score is, the more favorable and preferable the softness is.

A just-steamed rice was evaluated as Just-steamed Grade “A” when the score for 3 items of sensory evaluation totaled 10 or more. Further, a just-steamed rice was evaluated as Just-steamed Grade “B” when the score for 3 items of sensory evaluation totaled 8 or more and less than 10, and otherwise as Just-steamed Grade “C”. Similarly, variations over time 30 hours after normal-temperature storage were evaluated as Variations-over-time Grade “A” when the score for 3 items of sensory evaluation totaled 10 or more. Further, variations over time were evaluated as Variations-over-time Grade “B” when the score for 3 items of sensory evaluation totaled 8 or more and less than 10, and otherwise as Variations-over time Grade “C”. Further, a comprehensive evaluation was given as Comprehensive-evaluation Grade “SA” with the most favorable state, having the Just-steamed Grade “A” and Variations-over-time Grade “A”. Table 3 shows evaluation results of a just-steamed rice, and Table 4 shows evaluation results of variations over time and comprehensive evaluations. It is to be noted that a photo showing the state of the surface of a just-steamed rice (in the form of crab holes) is not cited herein.

TABLE 3

| | | Comparative | | | Example |
|---|---|---|---|---|---|
| | | 2-1 | 2-2 | 2-3 | 2 |
| Tasting timing | | Just after steaming rice | | | |
| PMEU (U/g of rice) | | 0 | 0.01 | 0 | 0.01 |
| GTFU (U/g of rice) | | 0 | 0 | 0.01 | 0.01 |
| Immediate | Water retention | 1.0 | 2.5 | 2.0 | 5.0 |
| evaluation | feeling | | | | |
| | Springy feeling | 1.0 | 1.5 | 2.5 | 5.0 |
| | Softness on the | 1.0 | 1.5 | 1.5 | 5.0 |
| | surface | | | | |
| | Total score | 3.0 | 5.5 | 6.0 | 15.0 |

| | | | | |
|---|---|---|---|---|
| Just-steamed Grade | C | C | C | A |

As shown in Table 3 showing an evaluation of a just-steamed glutinous rice, in relation to Comparative Example 2-1 (conventional type of steamed glutinous rice) where none of the enzymes was added, the score in Comparative Example 2-2 where only a PME enzyme was added was slightly higher, but the texture of the steamed glutinous rice was not improved, and the effect of the PME enzyme alone was insufficient. Meanwhile, in Comparative Example 2-3 where only a GTF enzyme was added, the score was slightly higher, but the texture of the steamed glutinous rice was not improved, and the effect of the GTF enzyme alone was insufficient.

In relation to these Comparative Examples, in Example 2 where a PME enzyme and a GTF enzyme were used in combination, the total score was 15, showing a significant improvement in the texture of the just-steamed glutinous rice. Consequently, in this Example 2, the rice was evaluated as Just-steamed Grade “A” from the results of the sensory evaluation.

TABLE 4

| | | Comparative | | | Example |
|---|---|---|---|---|---|
| | | 2-1 | 2-2 | 2-3 | 2 |
| Tasting timing | | 30 hours after | | | |
| | | normal-temperature storage | | | |
| PMEU (U/g of rice) | | 0 | 0.01 | 0 | 0.01 |
| GTFU (U/g of rice) | | 0 | 0 | 0.01 | 0.01 |
| Evaluation | Water | 1.0 | 2.0 | 1.5 | 4.5 |
| over time | retention | | | | |
| | feeling | | | | |
| | Springy | 1.0 | 1.5 | 2.0 | 4.5 |
| | feeling | | | | |
| | Softness on | 1.0 | 1.5 | 1.5 | 4.5 |
| | the surface | | | | |
| | Total score | 3.0 | 5.0 | 5.0 | 13.5 |
| Variations-over-time Grade | | C | C | C | A |
| Comprehensive | Just-steamed | C | C | C | A |
| evaluation | Grade | | | | |
| | Variations- | C | C | C | A |
| | over-time | | | | |
| | Grade | | | | |
| | Comprehensive | — | — | — | SA |
| | evaluation | | | | |

As shown in Table 4 showing the results of the sensory evaluation conducted 30 hours after normal-temperature storage of the just-steamed glutinous rice, the texture 30 hours after normal-temperature storage of the steamed glutinous rice was not favorable in Comparative Examples 2-1, 2-2, and 2-3. On the other hand, in the sensory evaluation of Example 2, the total score was 13.5 and the rice remained highly evaluated, showing a significant improvement in the texture 30 hours after normal-temperature storage of the steamed glutinous rice in relation to Comparative Example 2-1 (conventional type of steamed glutinous rice). Consequently, in this Example 2, the rice was evaluated as Variations-over time Grade “A” from the results of the sensory evaluation conducted 30 hours after normal-temperature storage of the steamed glutinous rice.

The results in Tables 3 and 4 found that in this Example 2, the rice was evaluated as Comprehensive Evaluation “SA” from both Just-steamed Grade and Variations-over-time Grade. Thus, a synergetic effect of a GTF enzyme and a PME enzyme successfully significantly improved the performance of a just-steamed glutinous rice and a rice after normal-temperature storage.

### Example 3

This Example 3 is directed to a cooked rice, using an α-A enzyme, a GTF enzyme, and a PME enzyme in combination. To inhibit the dry state on the surface of the cooked rice and retrogradation and increase the yield, the amount of water added for cooking rice is raised in view of economic efficiency. Nevertheless, rice grains cannot sufficiently absorb increased water added for cooking rice, which unfortunately makes the surface of just-cooked rice sticky. As another conventional problem, it is hard to properly shape just-cooked soft and sticky rice into rice balls.

Further, increases in water added for cooking rice deteriorate the convection in a large rice cooker for professional use due to heavier water weight, resulting in uneven cooked rice qualities at the upper, middle and lower parts in the cooker. A cooked rice at the lower part of the cooker, in particularly, is significantly crushed. The resultant uneven cooked rice quality, depending on the part in the cooker, fails to achieve stable manufacturing of cooked rice for professional use. To solve these various problems, the effect of using an α-A enzyme and a GTF enzyme alone or in combination for each problem is expected.

In this Example 3, it is confirmed that an α-A enzyme and a GTF enzyme are allowed to act on a rice for cooking the rice in combination with a PME enzyme to allow the PME enzyme to significantly enhance the effect of the α-A enzyme and the GTF enzyme. Inventors of the present invention believed that by loosening pectin layers present on the surface of rice grains by the effect of the PME enzyme, the effect of the α-A enzyme can be enhanced. Also, by loosening pectin layers by the effect of the PME enzyme, the effect of the GTF enzyme to modify an amylose and an amylopectin contained in a starch can be enhanced.

In addition, by using these enzymes in combination, each having even low rates to be added, the quality of the cooked rice can significantly be improved, resulting in highly commercially economic efficiencies. Further, the cooked rice was provided with a glutinous texture by an enhanced effect of the GTF enzyme from the effect of the PME enzyme and less watery property when chewing by water retention. Also, the effect of the PME enzyme enhanced the effect of the α-A enzyme, and the rice was provided with particulate appearance and less stickiness on the surface. Further, the cooked rice was successfully provided with long-duration water retention and texture such as springy texture, softness, and less stickiness on the surface.

### 1. Rice Cooking Operation

First, 450 g of raw rice (Aichi-no-kaori: a Japanese rice variety) was rinsed, and thereafter immersed in water such that the total weight of water and rice is 1,170 g and an amount of added water is 160%. A PME enzyme (0.01 PMEU per g of rice), an α-A enzyme (0.04 α-AU per g of rice), and a GTF enzyme (0.01 GTFU per g of rice) were added to a sample thus prepared in Example 3. The compositions of samples in Comparative Examples 3-1 to 3-7 are as follows.
Comparative Example 3-1: none of the enzymes added.
Comparative Example 3-2: only PME enzyme added (0.01 PMEU per g of rice),
Comparative Example 3-3: only α-A enzyme added (0.04 α-AU per g of rice),
Comparative Example 3-4: only GTF enzyme added (0.01 GTFU per g of rice),
Comparative Example 3-5: PME enzyme (0.01 PMEU per g of rice) and α-A enzyme (0.04 α-AU per g of rice) added,
Comparative Example 3-6: PME enzyme (0.01 PMEU per g of rice) and GTF enzyme (0.01 GTFU per g of rice) added,
Comparative Example 3-7: α-A enzyme (0.04 α-AU per g of rice) and GTF enzyme (0.01 GTFU per g of rice) added.

Thereafter, each of the samples was added to a rice to be cooked in a gas rice cooker with a cooking capacity of 5 cups of rice by normal operation. It is to be noted that in this Example 3, the α-A enzyme, the GTF enzyme, and the PME enzyme acted on a rice while cooking the rice from normal temperature to 100° C., particularly from normal temperature to approx. 85° C., after each of the enzymes was added.

### 2. Evaluation

In this Example 3, a just-cooked rice was evaluated from the texture of a cooked rice (a sensory evaluation), the convection in the cooker during cooking (a visual evaluation), and proper shaping. In addition, variations over time were evaluated from the texture of a cooked rice (a sensory evaluation) 30 hours after normal-temperature storage.

First, the texture was evaluated in terms of 4 items: water retention feeling, springy texture, softness on the surface, and less stickiness on the surface by score according to the sensory evaluation. Specifically, 4 skilled evaluators determined the texture ranging from 0 point (unfavorable) to 5 points (favorable), and averaged the score.

Herein, the water retention feeling refers to the state of rice grains to hold water with the watery surface, showing the higher the score is, the more favorable and preferable the water retention feeling is. The springy texture refers to a glutinous, resilient texture on the teeth when chewing, showing the higher the score is, the more favorable and preferable the springy texture is. The softness on the surface refers to less resiliency on the teeth when starting to chew, showing the higher the score is, the more favorable and preferable the softness is. The less stickiness on the surface refers to smooth surface of rice grains with less stickiness, showing the higher the score is, the less stickiness on the surface is and the more favorable and preferable the particulate appearance is.

Meanwhile, the convection while cooking a rice in the cooker was evaluated by visually confirming the state of the surface of a cooked rice and counting the number of trails of the convection of rice grains (hereinafter referred to as “crab holes”). Specifically, the convection was evaluated as favorable with 20 or more crab holes in relation to the cross-sectional area of the cooker used in this Example 3 (surface area of cooked rice: 266 cm²).

Four skilled evaluators judged the proper shaping ranging from 0 point (unfavorable) to 5 points (favorable) and averaged the score. Herein, the proper shaping refers to the state of the rice when the rice is not adhered to the hands to shape it into rice balls and rice grains are not crushed, showing the higher the score is, the more favorable and preferable the proper shaping is.

First, the just-cooked rice was evaluated as Just-cooked Grade “A” when the score for 4 items of a sensory evaluation totaled 14 or more, the crab holes totaled 20 or more, and the proper shaping score totaled 3 or more. Also, even if the crab holes totaled less than 20, a just-cooked rice was evaluated as Just-cooked Grade “B” with the score for 4 items of a sensory evaluation totaling 14 or more and the proper shaping score totaling 3 or more. It is to be noted that despite the number of crab holes and the score in the sensory evaluation, a just-cooked rice was evaluated as Just-cooked Grade “C” when the proper shaping score totaled less than 3.

Meanwhile, variations over time were evaluated, according to a sensory evaluation only, as Variations-over-time Grade “A” when the score for 4 items of a sensory evaluation 30 hours after normal-temperature storage totaled 14 or more. It is to be noted that variations over time were evaluated as Variations-over time Grade “C” when the score for 4 items of a sensory evaluation totaled less than 14.

A comprehensive evaluation was given as Comprehensive-evaluation Grade “SA” with the most favorable state, having the Just-cooked Grade “A” and Variations-over-time Grade “A”. Table s shows evaluation results of a just-cooked rice, and Table 6 shows evaluation results of variations over time and comprehensive evaluations. It is to be noted that a photo showing the state of the surface of a just-cooked rice (in the form of crab holes) is not cited herein.

TABLE 5

| | | Comparative | | | | | | | Example |
|---|---|---|---|---|---|---|---|---|---|
| | | 3-1 | 3-2 | 3-3 | 3-4 | 3-5 | 3-6 | 3-7 | 3 |
| Tasting timing | | Just after cooking | | | | | | | |
| PMEU | | 0 | 0.01 | 0 | 0 | 0.01 | 0.01 | 0 | 0.01 |
| (U/g of rice) | | | | | | | | | |
| α-AU | | 0 | 0 | 0.04 | 0 | 0.04 | 0 | 0.04 | 0.04 |
| (U/g of rice) | | | | | | | | | |
| GTFU | | 0 | 0 | 0 | 0.01 | 0 | 0.01 | 0.01 | 0.01 |
| (U/g of rice) | | | | | | | | | |
| Immediate | Water | 1.0 | 2.0 | 1.0 | 2.0 | 1.5 | 3.0 | 2.0 | 5.0 |
| sensory | retention | | | | | | | | |
| evaluation | feeling | | | | | | | | |
| | Springy | 1.0 | 2.0 | 1.0 | 2.5 | 2.0 | 2.0 | 2.0 | 5.0 |
| | feeling | | | | | | | | |
| | Softness on | 4.0 | 4.0 | 4.5 | 4.0 | 4.5 | 2.5 | 4.0 | 5.0 |
| | the surface | | | | | | | | |
| | Less | 1.0 | 2.0 | 3.0 | 1.0 | 4.0 | 3.0 | 4.0 | 5.0 |
| | stickiness | | | | | | | | |
| | on the | | | | | | | | |
| | surface | | | | | | | | |
| | Total score | 7.0 | 10.0 | 9.5 | 9.5 | 12.0 | 10.5 | 12.0 | 20.0 |
| Convection | Number of | 5 | 0 | 22 | 3 | 31 | 0 | 22 | 34 |
| evaluation | crab holes | | | | | | | | |
| Shaping | Score | 1.0 | 1.5 | 1.5 | 1.5 | 1.0 | 2.0 | 2.0 | 5.0 |
| property | | | | | | | | | |

| | | | | | | | | |
|---|---|---|---|---|---|---|---|---|
| Just-cooked Grade | C | C | C | C | C | C | C | A |

As shown in Table 5 showing an evaluation of a just-cooked rice, in relation to Comparative Example 3-1 (conventional type of cooked rice) where none of the enzymes was added, no crab holes were found in Comparative Example 3-2 where only a PME enzyme was added and the convection was not improved. However, in a sensory evaluation, the score in Comparative Example 3-2 was higher than in Comparative Example 3-1, but the texture of the cooked rice was not sufficiently improved, and the effect of the PME enzyme alone was insufficient. Further, an evaluation of the proper shaping with increased water added for cooking rice in Comparative Example 3-2 showed that the score was slightly higher than in Comparative Example 3-1, but it had no sufficient shaping property, and the effect of the PME enzyme alone was insufficient.

In addition, in Comparative Example 3-3 where only an α-A enzyme was added, 22 crab holes were found to show an improvement in the convection. This improvement can be evaluated due to the effect of the α-A enzyme to decompose the stickiness on the surface of rice grains and stably mix the rice grains at the upper, middle and lower parts of the cooker. However, in a sensory evaluation, the score in Comparative Example 3-3 was higher than in Comparative Example 3-1, but the texture of the cooked rice was not sufficiently improved, and the effect of the α-A enzyme alone was insufficient. Further, an evaluation of the proper shaping in Comparative Example 3-3 showed that the score was slightly higher than in Comparative Example 3-1, but it had no sufficient shaping property, and the effect of the α-A enzyme alone was insufficient.

In addition, in Comparative Example 3-4 where only a GTF enzyme was added, 3 crab holes were found, but the extent was similar to Comparative Example 3-1 (conventional type of cooked rice), showing no improvement in the convection. It is to be noted that in a sensory evaluation, the score in Comparative Example 3-4 was higher than in Comparative Example 3-1, but the texture of the cooked rice was not sufficiently improved, and the effect of the GTF enzyme alone was insufficient. Further, an evaluation of the proper shaping in Comparative Example 3-4 showed that the score was slightly higher than in Comparative Example 3-1, but it had no sufficient shaping property, and the effect of the GTF enzyme alone was insufficient.

Subsequently, Comparative Examples 3-5 to 3-7 using 2 types of enzymes in combination will be discussed. First, in Comparative Example 3-5 where an α-A enzyme and a PME enzyme were used in combination, 31 crab holes were found to show an improvement in the convection. In this regard, since the effect of the PME enzyme loosens pectin layers on the surface of rice grains, the effect of the α-A enzyme decomposes the stickiness on the surface of rice grains surface and stably mixes the rice grains at the upper, middle and lower parts of the cooker. However, in a sensory evaluation, the score in Comparative Example 3-5 was higher than in Comparative Example 3-1, but the texture of the cooked rice was not sufficiently improved, and the effect of the α-A enzyme and the PME enzyme in combination was insufficient. Further, an evaluation of the proper shaping showed that the score in Comparative Example 3-5 was the same as in Comparative Example 3-1, it had no sufficient shaping property, and the effect of the α-A enzyme and the PME enzyme in combination was insufficient.

Also, in Comparative Example 3-6 where a GTF enzyme and a PME enzyme were used in combination, no crab holes were found to show no improvement in the convection. In addition, in a sensory evaluation, the score in Comparative Example 3-6 was higher than in Comparative Example 3-1, but the texture of the cooked rice was not sufficiently improved, and the effect of the GTF enzyme and the PME enzyme in combination was insufficient. Further, an evaluation of the proper shaping showed that the score in Comparative Example 3-6 was higher than in Comparative Example 3-1, but it had no sufficient shaping property, and the effect of the GTF enzyme and the PME enzyme in combination was insufficient.

Also, in Comparative Example 3-7 where an α-A enzyme and a GTF enzyme were used in combination, 22 crab holes were found to show an improvement in the convection. This improvement can be evaluated due to the effect of the α-A enzyme to decompose the stickiness on the surface of rice grains, and the effect of the GTF enzyme to modify an amylose and an amylopectin contained in a starch and stably mix the rice grains at the upper, middle and lower parts of the cooker. In addition, in a sensory evaluation, the score in Comparative Example 3-7 was higher than in Comparative Example 3-1, but the texture of the cooked rice was not sufficiently improved, and the effect of the α-A enzyme and the GTF enzyme in combination was insufficient. Further, an evaluation of the proper shaping showed that the score in Comparative Example 3-7 was higher than in Comparative Example 3-1, but it had no sufficient shaping property, and the effect of the α-A enzyme and the GTF enzyme in combination was insufficient.

In relation to these Comparative Examples, in Example 3 where an α-A enzyme, a GTF enzyme and a PME enzyme were used in combination, 34 crab holes were found to show much more improvement in the convection than in Comparative Example 3-1 (conventional type of cooked rice). In this regard, since the effect of the PME enzyme loosens pectin layers on the surface of rice grains, the effect of the α-A enzyme decomposes the stickiness on the surface of rice grains, and the effect of the GTF enzyme modifies an amylose and an amylopectin contained in a starch and stably mixes the rice grains at the upper, middle and lower parts of the cooker. In the sensory evaluation in Example 3, the total score was 20, showing a significant improvement in the texture of a just-cooked rice despite with increased water added for cooking rice. Further, the proper shaping was evaluated with a high score of 5.0, sufficiently confirming the effect of an α-A enzyme, a GTF enzyme, and a PME enzyme in combination with increased water added for cooking rice. Consequently, in this Example 3, the rice was evaluated as Just-cooked Grade “A” from the results of the sensory evaluation, convection evaluation and shaping property evaluation.

TABLE 6

| | | Comparative | | | | | | | Example |
|---|---|---|---|---|---|---|---|---|---|
| | | 3-1 | 3-2 | 3-3 | 3-4 | 3-5 | 3-6 | 3-7 | 3 |
| Tasting timing | | 30 hours after normal-temperature sotage | | | | | | | |
| PMEU (U/g of rice) | | 0 | 0.01 | 0 | 0 | 0.01 | 0.01 | 0 | 0.01 |
| α-AU (U/g of rice) | | 0 | 0 | 0.04 | 0 | 0.04 | 0 | 0.04 | 0.04 |
| GTFU (U/g of rice) | | 0 | 0 | 0 | 0.01 | 0 | 0.01 | 0.01 | 0.01 |
| Sensory | Water retention | 1.0 | 1.5 | 1.0 | 1.5 | 1.5 | 2.5 | 2.0 | 4.5 |
| evaluation | feeling | | | | | | | | |
| over time | Springy feeling | 1.0 | 1.5 | 1.0 | 2.0 | 2.0 | 2.0 | 2.0 | 4.5 |
| | Softness on the | 1.0 | 3.0 | 3.5 | 3.0 | 3.5 | 2.5 | 4.0 | 4.5 |
| | surface | | | | | | | | |
| | Less stickiness | 3.0 | 2.0 | 3.5 | 1.0 | 4.5 | 5.0 | 4.0 | 4.5 |
| | on the surface | | | | | | | | |
| | Total score | 6.0 | 8.0 | 9.0 | 7.5 | 11.5 | 12.0 | 12.0 | 18.0 |
| Variations-over-time Grade | | C | C | C | C | C | C | C | A |
| Comprehensive | Just-cooked Grade | C | C | C | C | C | C | C | A |
| evaluation | Variations-over- | C | C | C | C | C | C | C | A |
| | time Grade | | | | | | | | |
| | Comprehensive | — | — | — | — | — | — | — | SA |
| | evaluation | | | | | | | | |

As shown in Table 6 showing a sensory evaluation conducted 30 hours after normal-temperature storage of a cooked rice, the texture 30 hours after normal-temperature storage of the cooked rice was not favorable in Comparative Examples 3-1 to 3-7. On the other hand, in the sensory evaluation in Example 3, the total score was 18 and the rice remained highly evaluated, showing much more improvement in the texture 30 hours after normal-temperature storage of the cooked rice than Comparative Example 3-1 (conventional type of cooked rice). Consequently, in this Example 3, the rice was evaluated as Variations-over-time Grade “A” from the results of the sensory evaluation conducted 30 hours after normal-temperature storage of the cooked rice.

The results in Tables 5 and 6 found that in this Example 3, the rice was evaluated as Comprehensive Evaluation “SA” from both Just-cooked Grade and Variations-over-time Grade. Thus, a synergetic effect of an α-A enzyme, a GTF enzyme, and a PME enzyme successfully significantly improved the performance of a just-cooked rice and a rice after normal-temperature storage.

### Example 4

This Example 4 is directed to a vinegared rice from Japanese rice, using an α-A enzyme, a GTF enzyme, and a PME enzyme in combination. To inhibit the dry state on the surface of the vinegared rice and retrogradation and increase the yield, the amount of water added for cooking rice is raised in view of economic efficiency. Nevertheless, rice grains cannot sufficiently absorb increased water added for cooking rice, which unfortunately makes the surface of just-cooked rice sticky. As another conventional problem, it is hard to maintain a proper texture of a vinegared rice from just-cooked soft and sticky rice and shape it into sushi.

Further, increases in water added for cooking rice deteriorate the convection in a large rice cooker for professional use due to heavier water weight, resulting in uneven rice qualities at the upper, middle and lower parts in the cooker. A cooked rice at the lower part of the cooker, in particularly, is significantly crushed. The resultant uneven cooked rice quality, depending on the part in the cooker, fails to achieve stable manufacturing of cooked rice for professional use. To solve these various problems, the effect of using an α-A enzyme and a GTF enzyme alone or in combination for each problem is expected.

In this Example 4, it is confirmed that an α-A enzyme and a GTF enzyme are allowed to act on a rice for cooking the rice in combination with a PME enzyme to allow the PME enzyme to significantly enhance the effect of the α-A enzyme and the GTF enzyme. Inventors of the present invention believed that by loosening pectin layers present on the surface of rice grains by the effect of the PME enzyme, the effect of the α-A enzyme can be enhanced. Also, by loosening pectin layers by the effect of the PME enzyme, the effect of the GTF enzyme to modify an amylose and an amylopectin contained in a starch can be enhanced.

In addition, by using these enzymes in combination, each having even low rates added, the quality of the vinegared rice can significantly be improved, resulting in highly commercially economic efficiencies. Further, the prepared vinegared rice was provided with a glutinous texture by an enhanced effect of the GTF enzyme from the effect of the PME enzyme and less watery property when chewing by water retention. Also, the effect of the PME enzyme enhanced the effect of the α-A enzyme, and the rice was provided with particulate appearance and less stickiness on the surface. Further, the vinegared rice from cooked rice was provided with long-duration water retention and texture such as springy texture, softness, and less stickiness on the surface.

### 1. Preparation Operation of Cooked Rice and Vinegared Rice

First, 450 g of raw rice (Aichi-no-kaori: a Japanese rice variety) was rinsed, and thereafter immersed in water such that the total weight of water and rice is 1,170 g and an amount of added water is 160%. A PME enzyme (0.01 PMEU per g of rice), an α-A enzyme (0.04 α-AU per g of rice), and a GTF enzyme (0.01 GTFU per g of rice) were added to a sample thus prepared in Example 4. The compositions of samples in Comparative Examples 4-1 to 4-7 are as follows.
Comparative Example 4-1: none of the enzymes added,
Comparative Example 4-2: only PME enzyme added (0.01 PMEU per g of rice),
Comparative Example 4-3: only α-A enzyme added (0.04 α-AU per g of rice),
Comparative Example 4-4: only GTF enzyme added (0.01 GTFU per g of rice),
Comparative Example 4-5: PME enzyme (0.01 PMEU per g of rice) and α-A enzyme (0.04 α-AU per g of rice) added,
Comparative Example 4-6: PME enzyme (0.01 PMEU per g of rice) and GTF enzyme (0.01 GTFU per g of rice) added,
Comparative Example 4-7: α-A enzyme (0.04 α-AU per g of rice) and GTF enzyme (0.01 GTFU per g of rice) added.

Thereafter, each of the samples was added to a rice to be cooked in a gas rice cooker with a cooking capacity of 5 cups of rice by normal operation. 166.5 g of vinegar was added to a cooked rice to prepare a vinegared rice. It is to be noted that in this Example 4, the α-A enzyme, the GTF enzyme, and the PME enzyme acted on a rice while cooking the rice from normal temperature to 10) ° C., particularly from normal temperature to approx. 85° C., after each of the enzymes was added.

### 2. Evaluation

In this Example 4, a just-cooked rice (after preparing vinegared rice) was evaluated from the texture of a vinegared rice (a sensory evaluation), the convection in the cooker during cooking rice (a visual evaluation), and proper shaping. In addition, variations over time were evaluated from the texture of a vinegared rice (a sensory evaluation) 72 hours after refrigeration storage.

First, the texture was evaluated in terms of 4 items: water retention feeling, springy texture, softness on the surface, and less stickiness on the surface by score according to the sensory evaluation. Specifically, 4 skilled evaluators determined the texture ranging from 0 point (unfavorable) to 5 points (favorable), and averaged the score.

Herein, the water retention feeling refers to the state of rice grains to hold water with the watery surface, showing the higher the score is, the more favorable and preferable the water retention feeling is. The springy texture refers to a glutinous, resilient texture on the teeth when chewing, showing the higher the score is, the more favorable and preferable the springy texture is. The softness on the surface refers to less resiliency on the teeth when starting to chew, showing the higher the score is, the more favorable and preferable the softness is. The less stickiness on the surface refers to smooth surface of rice grains with less stickiness, showing the higher the score is, the less stickiness on the surface is and the more favorable and preferable the particulate appearance is.

Meanwhile, the convection while cooking a rice in the cooker was evaluated by visually confirming the state of the surface of a cooked rice (before preparing vinegared rice) and counting the number of trails of the convection of rice grains (hereinafter referred to as “crab hole”). Specifically, the convection was evaluated as favorable with 20 or more crab holes in relation to the cross-sectional area of the cooker used in this Example 4 (surface area of cooked rice: 266 cm²).

Four skilled evaluators judged the proper shaping ranging from 0 point (unfavorable) to 5 points (favorable) and averaged the score. Herein, the proper shaping refers to the state of the rice when the vinegared rice is not adhered to the hands to shape it and rice grains are not crushed, showing the higher the score is, the more favorable the proper shaping is.

First, the just-cooked rice (after preparing vinegared rice) was evaluated as Just-cooked Grade “A” when the score for 4 items of a sensory evaluation totaled 14 or more, the crab holes totaled 20 or more, and the proper shaping score totaled 3 or more. Also, even if the crab holes totaled less than 20, a just-cooked rice was evaluated as Just-cooked Grade “B” with the score for 4 items of a sensory evaluation totaling 14 or more and the proper shaping score totaling 3 or more. It is to be noted that despite the number of crab holes and the score in the sensory evaluation, a just-cooked rice was evaluated as Just-cooked Grade “C” when the proper shaping score totaled less than 3.

Meanwhile, variations over time were evaluated, according to a sensory evaluation only, as Variations-over-time Grade “A” when the score for 4 items of a sensory evaluation 72 hours after refrigeration storage totaled 14 or more. It is to be noted that variations over time were evaluated as Variations-over time Grade “C” when the score for 4 items of a sensory evaluation totaled less than 14.

A comprehensive evaluation was given as Comprehensive-evaluation Grade “SA” with the most favorable state, having the Just-cooked Grade “A” and Variations-over-time Grade “A”. Table 7 shows evaluation results of a just-cooked rice, and Table 8 shows evaluation results of variations over time and comprehensive evaluations. It is to be noted that a photo showing the state of the surface of a just-cooked rice (in the form of crab holes) is not cited herein.

TABLE 7

| | | Comparative | | | | | | | Example |
|---|---|---|---|---|---|---|---|---|---|
| | | 4-1 | 4-2 | 4-3 | 4-4 | 4-5 | 4-6 | 4-7 | 4 |
| Tasting timing | | Just after cooking rice | | | | | | | |
| | | (after preparing vinegared rice) | | | | | | | |
| PMEU (U/g of rice) | | 0 | 0.1 | 0 | 0 | 0.01 | 0.01 | 0 | 0.01 |
| α-AU (U/g of rice) | | 0 | 0 | 0.04 | 0 | 0.04 | 0 | 0.04 | 0.04 |
| GTFU (U/g of rice) | | 0 | 0 | 0 | 0.01 | 0 | 0.01 | 0.01 | 0.01 |
| Immediate | Water | 1.0 | 2.0 | 1.0 | 2.0 | 1.5 | 3.0 | 2.0 | 5.0 |
| sensory | retention | | | | | | | | |
| evaluation | feeling | | | | | | | | |
| | Springy | 1.0 | 2.0 | 1.0 | 2.5 | 2.0 | 2.0 | 2.0 | 5.0 |
| | feeling | | | | | | | | |
| | Softness on | 4.0 | 4.0 | 4.5 | 4.0 | 4.5 | 2.5 | 4.0 | 5.0 |
| | the surface | | | | | | | | |
| | Less | 1.0 | 2.0 | 3.0 | 1.0 | 4.0 | 3.0 | 4.0 | 5.0 |
| | stickiness | | | | | | | | |
| | on the | | | | | | | | |
| | surface | | | | | | | | |
| | Total score | 7.0 | 10.0 | 9.5 | 9.5 | 12.0 | 10.5 | 12.0 | 20.0 |
| Convection | Number of | 5 | 0 | 22 | 3 | 31 | 0 | 22 | 34 |
| evaluation | crab holes | | | | | | | | |
| Sharing | Score | 1.0 | 1.5 | 1.5 | 1.5 | 1.0 | 2.0 | 2.0 | 5.0 |
| property | | | | | | | | | |

| | | | | | | | | |
|---|---|---|---|---|---|---|---|---|
| Just-cooked Grade | C | C | C | C | C | C | C | A |

As shown in Table 7 showing an evaluation of a vinegared rice prepared from a just-cooked rice, in relation to Comparative Example 4-1 (conventional type of cooked rice) where none of the enzymes was added, no crab holes were found in Comparative Example 4-2 where only a PME enzyme was added and the convection was not improved. However, in a sensory evaluation, the score in Comparative Example 4-2 was higher than in Comparative Example 4-1, but the texture of the vinegared rice was not sufficiently improved, and the effect of the PME enzyme alone was insufficient. Further, an evaluation of the proper shaping with increased water added for cooking rice in Comparative Example 4-2 showed that the score was slightly higher than in Comparative Example 4-1, but it had no sufficient shaping property, and the effect of the PME enzyme alone was insufficient.

In addition, in Comparative Example 4-3 where only an α-A enzyme was added, 22 crab holes were found to show an improvement in the convection. This improvement can be evaluated due to the effect of the α-A enzyme to decompose the stickiness on the surface of rice grains and stably mix the rice grains at the upper, middle and lower parts of the cooker. However, in a sensory evaluation, the score in Comparative Example 4-3 was higher than in Comparative Example 4-1, but the texture of the vinegared rice was not sufficiently improved, and the effect of the α-A enzyme alone was insufficient. Further, an evaluation of the proper shaping in Comparative Example 4-3 showed that the score was slightly higher than in Comparative Example 4-1, but it had no sufficient shaping property, and the effect of the α-A enzyme alone was insufficient.

In addition, in Comparative Example 4-4 where only a GTF enzyme was added, 3 crab holes were found, but the extent was similar to Comparative Example 4-1 (conventional type of cooked rice), showing no improvement in the convection. It is to be noted that in a sensory evaluation, the score in Comparative Example 4-4 was higher than in Comparative Example 4-1, but the texture of the vinegared rice was not sufficiently improved, and the effect of the GTF enzyme alone was insufficient. Further, an evaluation of the proper shaping in Comparative Example 4-4 showed that the score was slightly higher than in Comparative Example 4-1, but it had no sufficient shaping property, and the effect of the GTF enzyme alone was insufficient.

Subsequently, Comparative Examples 4-5 to 4-7 using 2 types of enzymes in combination will be discussed. First, in Comparative Example 4-5 where an α-A enzyme and a PME enzyme were used in combination, 31 crab holes were found to show an improvement in the convection. In this regard, since the effect of the PME enzyme loosens pectin layers on the surface of rice grains, the effect of the α-A enzyme decomposes the stickiness on the surface of rice grains surface and stably mixes the rice grains at the upper, middle and lower parts of the cooker. However, in a sensory evaluation, the score in Comparative Example 4-5 was higher than in Comparative Example 4-1, but the texture of the vinegared rice was not sufficiently improved, and the effect of the α-A enzyme and the PME enzyme in combination was insufficient. Further, an evaluation of the proper shaping showed that the score in Comparative Example 4-5 was the same as in Comparative Example 4-1, it had no sufficient shaping property, and the effect of the α-A enzyme and the PME enzyme in combination was insufficient.

Also, in Comparative Example 4-6 where a GTF enzyme and a PME enzyme were used in combination, in a sensory evaluation, the score in Comparative Example 4-6 was higher than in Comparative Example 4-1, but the texture of the vinegared rice was not sufficiently improved, and the effect of the GTF enzyme and the PME enzyme in combination was insufficient. Further, an evaluation of the proper shaping showed that the score in Comparative Example 4-6 was higher than in Comparative Example 4-1, but it had no sufficient shaping property, and the effect of the GTF enzyme and the PME enzyme in combination was insufficient.

Also, in Comparative Example 4-7 where an α-A enzyme and a GTF enzyme were used in combination, 22 crab holes were found to show an improvement in the convection. This improvement can be evaluated due to the effect of the α-A enzyme to decompose the stickiness on the surface of rice grains, and the effect of the GTF enzyme to modify an amylose and an amylopectin contained in a starch and stably mix the rice grains at the upper, middle and lower parts of the cooker. In addition, in a sensory evaluation, the score in Comparative Example 4-7 was higher than in Comparative Example 4-1, but the texture of the vinegared rice was not sufficiently improved, and the effect of the α-A enzyme and the GTF enzyme in combination was insufficient. Further, an evaluation of the proper shaping showed that the score in Comparative Example 4-7 was higher than in Comparative Example 4-1, but it had no sufficient shaping property, and the effect of the α-A enzyme and the GTF enzyme in combination was insufficient.

In relation to these Comparative Examples, in Example 4 where an α-A enzyme, a GTF enzyme and a PME enzyme were used in combination, 34 crab holes were found to show much more improvement in the convection than in Comparative Example 4-1 (conventional type of cooked rice). In this regard, since the effect of the PME enzyme loosens pectin layers on the surface of rice grains, the effect of the α-A enzyme decomposes the stickiness on the surface of rice grains, and the effect of the GTF enzyme modifies an amylose and an amylopectin contained in a starch and stably mixes the rice grains at the upper, middle and lower parts of the cooker. In the sensory evaluation in Example 4, the total score was 20, showing a significant improvement in the texture of a just-cooked rice despite with increased water added for cooking rice. Further, the proper shaping was evaluated with a high score of 5.0, sufficiently confirming the effect of an α-A enzyme, a GTF enzyme, and a PME enzyme in combination with increased water added for cooking rice. Consequently, in this Example 4, the rice was evaluated as Just-cooked Grade “A” from the results of the sensory evaluation, convection evaluation and shaping property evaluation.

TABLE 8

| | | Comparative | | | | | | | Example |
|---|---|---|---|---|---|---|---|---|---|
| | | 4-1 | 4-2 | 4-3 | 4-4 | 4-5 | 4-6 | 4-7 | 4 |
| Tasting timing | | 72 hours after refrigeration storage | | | | | | | |
| PMEU (U/g of rice) | | 0 | 0.1 | 0 | 0 | 0.01 | 0.01 | 0 | 0.01 |
| α-AU (U/g of rice) | | 0 | 0 | 0.04 | 0 | 0.04 | 0 | 0.04 | 0.04 |
| GTFU (U/g of rice) | | 0 | 0 | 0 | 0.01 | 0 | 0.01 | 0.01 | 0.01 |
| Sensory | Water | 1.0 | 1.5 | 1.0 | 1.5 | 1.5 | 2.5 | 2.0 | 4.0 |
| evaluation | retention | | | | | | | | |
| over time | feeling | | | | | | | | |
| | Springy | 1.0 | 1.5 | 1.0 | 2.0 | 2.0 | 2.0 | 2.0 | 4.0 |
| | feeling | | | | | | | | |
| | Softness on | 1.0 | 2.5 | 1.5 | 1.5 | 2.5 | 2.0 | 2.5 | 4.0 |
| | the surface | | | | | | | | |
| | Less | 3.0 | 2.0 | 3.5 | 1.0 | 4.5 | 4.5 | 4.5 | 5.0 |
| | stickiness on | | | | | | | | |
| | the surface | | | | | | | | |
| | Total score | 6.0 | 7.5 | 7.0 | 6.0 | 10.5 | 11.0 | 11.0 | 17.0 |
| Variations-over-time Grade | | C | C | C | C | C | C | C | A |
| Comprehensive | Just-cooked | C | C | C | C | C | C | C | A |
| evaluation | Grade | C | C | C | C | C | C | C | A |
| | Comprehensive | — | — | — | — | — | — | — | SA |
| | evaluation | | | | | | | | |

As shown in Table 8 showing a sensory evaluation of a vinegared rice prepared from just-cooked rice conducted 72 hours after refrigeration storage, the texture 72 hours after refrigeration storage was not favorable in Comparative Examples 4-1 to 3-7. On the other hand, in the sensory evaluation in Example 4, the total score was 17 and the rice remained highly evaluated, showing much more improvement in the texture 72 hours after refrigeration storage than Comparative Example 4-1 (conventional type of vinegared rice). Consequently, in this Example 4, the rice was evaluated as Variations-over-time Grade “A” from the results of the sensory evaluation conducted 72 hours after refrigeration storage.

The results in Tables 7 and 8 found that in this Example 4, the rice was evaluated as Comprehensive Evaluation “SA” from both Just-cooked Grade and Variations-over-time Grade. Thus, a synergetic effect of an α-A enzyme, a GTF enzyme, and a PME enzyme successfully significantly improved the performance of vinegared rice just after cooking and after refrigeration storage.

### Example 5

This Example 5 is directed to a vinegared rice from American rice, while the above Example 4 is directed to a vinegared rice from Japanese rice. It is to be noted that in this Example 5, a PTE enzyme was used as a pectinase, in place of a PME enzyme in the above Example 4, in combination with a GTF enzyme. The rice polishing degree of a vinegared rice from American rice is higher than that of Japanese rice, and the state of layers on the surface of rice grains and pectin distribution seem to vary.

Thus, it was confirmed that combinations of enzymes in this Example 5 can provide more proper texture of a vinegared rice and extended refrigeration storage than combinations of enzymes in the above Example 4. It is to be noted that in this Example 5, the texture of American rice was mainly evaluated, and there were no problems with the shaping property. In cases where American rice with a higher rice polishing degree is used, the convection in the cooker for cooking rice (number of crab holes) is not herein evaluated because it is not problematic.

In this Example 5, it is confirmed that an GTF enzyme is allowed to act on a rice for cooking the rice in combination with a PTE enzyme to allow the PTE enzyme to significantly enhance the effect of the GTF enzyme. Inventors of the present invention conceived the effect different from that in the above Example 4 in view of the state of layers on the surface of rice grains due to a high rice polishing degree of American rice. Specifically, the effect of a PTE enzyme directly decomposes a pectic material and provides permeability of rice grains and water retention feeling, and improves springy texture of a vinegared rice and water retention by the effect of the GTF enzyme to modify an amylose and an amylopectin contained in a starch. Accordingly, the inventors believed that a vinegared rice provided with a favorable texture which can endure extended refrigeration storage can be manufactured.

### 1. Preparation Operation of Cooked Rice and Vinegared Rice

First, 450 g of raw rice (an American rice variety) was rinsed, and thereafter immersed in water such that the total weight of water and rice is 1.170 g and an amount of added water is 160%. A PTE enzyme (0.0004 PTEU per g of rice) and a GTF enzyme (0.01 GTFU per g of rice) were added to a sample thus prepared in Example 5. The compositions of samples in Comparative Examples 5-1 to 5-3 are as follows.
Comparative Example 5-1: none of the enzymes added,
Comparative Example 5-2: only PTE enzyme added (0.0004 PTEU per g of rice),
Comparative Example 5-3: only GTF enzyme added (0.01 GTFU per g of rice).

Thereafter, each of the samples was added to a rice to be cooked in a gas rice cooker with a cooking capacity of 5 cups of rice by normal operation. 166.5 g of vinegar was added to a cooked rice to prepare a vinegared rice. It is to be noted that in this Example 5, the GTF enzyme and the PTE enzyme acted on a rice while cooking the rice from normal temperature to 100° C. particularly from normal temperature to approx. 85° C., after each of the enzymes was added.

### 2. Evaluation

In this Example 5, a just-cooked rice (after preparing vinegared rice) was evaluated from the texture of a vinegared rice (a sensory evaluation). In addition, variations over time were evaluated from the texture of a vinegared rice (a sensory evaluation) 72 hours after refrigeration storage.

First, the texture was evaluated in terms of 3 items: water retention feeling, springy texture, and softness on the surface by score according to sensory evaluation. Specifically, 4 skilled evaluators determined the texture ranging from 0 point (unfavorable) to 5 points (favorable), and averaged the score. It is to be noted that the texture (less stickiness on the surface) for vinegared rice from American rice was not evaluated because it was not particularly problematic.

Herein, the water retention feeling refers to the state of rice grains to hold water with the watery surface, showing the higher the score is, the more favorable and preferable the water retention feeling is. The springy texture refers to a glutinous, resilient texture on the teeth when chewing, showing the higher the score is, the more favorable and preferable the springy texture is. The softness on the surface refers to less resiliency on the teeth when starting to chew, showing the higher the score is, the more favorable and preferable the softness is.

First, the just-cooked rice (after preparing vinegared rice) was evaluated as Just-cooked Grade “A” when the score for 3 items of a sensory evaluation totaled 10 or more. In addition, variations over time were evaluated as Variations-over-time Grade “B” when the score for 3 items of a sensory evaluation totaled 8 or more and less than 10, and otherwise as Variations-over-time Grade “C”. Meanwhile, variations overtime were evaluated, according to a sensory evaluation, as Variations-over-time Grade “A” when the score for 3 items of a sensory evaluation 72 hours after refrigeration storage totaled 10 or more. In addition, variations over time were evaluated as Variations-over-time Grade “B” when the score for 3 items of a sensory evaluation totaled 8 or more and less than 10, and otherwise as Variations-over-time Grade “C”.

A comprehensive evaluation was given as Comprehensive-evaluation Grade “SA” with the most favorable state, having the Just-cooked Grade “A” and Variations-over-time Grade “A”. Table 9 shows evaluation results of a just-cooked rice, and Table 10 shows evaluation results of variations over time and comprehensive evaluations.

TABLE 9

| | | Comparative | | | Example |
|---|---|---|---|---|---|
| | | 5-1 | 5-2 | 5-3 | 5 |
| Tasting timing | | Just after cooking rice | | | |
| | | (after preparing vinegared rice) | | | |
| PTEU (U/g of rice) | | 0 | 0.0004 | 0 | 0.0004 |
| GTFU (U/g of rice) | | 0 | 0 | 0.01 | 0.01 |
| Immediate | Water retention | 1.0 | 2.0 | 2.0 | 4.0 |
| evaluation | feeling | | | | |
| | Springy feeling | 1.0 | 2.0 | 2.5 | 3.5 |
| | Softness on the | 4.0 | 4.0 | 4.0 | 3.5 |
| | surface | | | | |
| | Total score | 6.0 | 8.0 | 8.5 | 11.0 |

| | | | | |
|---|---|---|---|---|
| Just-cooked Grade | C | B | B | A |

As shown in Table 9 showing an evaluation of a vinegared rice prepared from a just-cooked rice, in relation to Comparative Example 5-1 (conventional type of cooked rice) where none of the enzymes was added, the score in Comparative Example 5-2 where only a PTE enzyme was added was higher than in Comparative Example 5-1, but the texture of the vinegared rice was not sufficiently improved, and the effect of the PTE enzyme alone was insufficient.

In addition, in Comparative Example 5-3 where only a GTF enzyme was added, the score was higher than in Comparative Example 5-1, but the texture of the vinegared rice was not sufficiently improved, and the effect of the GTF enzyme alone was insufficient.

In relation to these Comparative Examples, in Example 5 where a GTF enzyme and a PTE enzyme were used in combination, the total score was 11, showing a significant improvement in the texture of a just-cooked rice. Consequently, in this Example 5, the rice was evaluated as Just-steamed Grade “A”.

TABLE 10

| | | Comparative | | | Example |
|---|---|---|---|---|---|
| | | 5-1 | 5-2 | 5-3 | 5 |
| Tasting timing | | 72 hours after refrigeration storage | | | |
| PTEU (U/g of rice) | | 0 | 0.0004 | 0 | 0.0004 |
| GTFU (U/g of rice) | | 0 | 0 | 0.01 | 0.01 |
| Evaluation | Water | 1.0 | 1.5 | 1.5 | 3.0 |
| over time | retention | | | | |
| | feeling | | | | |
| | Springy | 1.0 | 1.0 | 2.0 | 3.5 |
| | feeling | | | | |
| | Softness on | 1.0 | 2.5 | 1.5 | 3.5 |
| | the surface | | | | |
| | Total score | 3.0 | 5.0 | 5.0 | 10.0 |
| Variations-over-time Grade | | C | C | C | A |
| Comprehensive | Just-cooked | C | B | B | A |
| evaluation | Grade | | | | |
| | Variations- | C | C | C | A |
| | over-time | | | | |
| | Grade | | | | |
| | Comprehensive | — | — | — | SA |
| | evaluation | | | | |

As shown in Table 10 showing a sensory evaluation of a vinegared rice prepared from just-cooked rice conducted 72 hours after refrigeration storage, the texture 72 hours after refrigeration storage was not favorable in Comparative Examples 5-1 to 5-3. On the other hand, in the sensory evaluation in Example 5, the total score was 10 and the rice remained highly evaluated, showing much more improvement in the texture 72 hours after refrigeration storage than Comparative Example 5-1 (conventional type of vinegared rice). Consequently, in this Example 5, the rice was evaluated as Variations-over-time Grade “A”.

The results in Tables 9 and 10 found that in this Example 5, the rice was evaluated as Comprehensive Evaluation “SA” from both Just-cooked Grade and Variations-over time-Grade. Thus, a synergetic effect of a PTE enzyme and a GTF enzyme successfully significantly improved the performance of vinegared rice even from American rice just after cooking and after refrigeration storage.

As described above, the present invention can provide a cooked rice quality improver capable of improving the texture of a cooked rice and extended texture stability so as to meet demands in the food industry, a cooked rice using the same, and a method for manufacturing the cooked rice.

It is to be noted that the present invention is achieved not only by each of the above embodiments, but also by the following various alternatives.

(1) In the above Examples 1 to 4, an enzyme contained in a cooked rice quality improver used was a pectinase produced by Aspergillus niger. However, such an enzyme is not restricted to that, and may be a pectinase originating in other microorganism.

(2) In the above Examples 1 to 4, an enzyme contained in a food performance improver used was a pectinase which is substantially free of a polygalacturonase activity and a pectin lyase activity and has a strong pectin methylesterase activity. However, such an enzyme is not restricted to that, and may be an enzyme having a polygalacturonase activity and a pectin lyase activity.

(3) In the above Example 5, an enzyme contained in a cooked rice quality improver used was a pectinase having a pectintranseliminase activity produced by Aspergillus japonicus. However, such an enzyme is not restricted to that, and may be a pectinase originating in other microorganism.

(4) In the above Examples 1, 3, and 4, an enzyme contained in a cooked rice quality improver used was an endo-type α-amylase produced by Bacillus amyloliquefaciens. However, such an enzyme is not restricted to that, and may be a pectinase originating in other microorganism.

(5) In the above Examples 2 to 5, an enzyme contained in a cooked rice quality improver used was a glucosyltransferase produced by Aeribacillus pallidus having a 4-α-glucanotransferase activity. However, such an enzyme is not restricted to that, and may be a glucosyltransferase originating in other microorganism.

(6) Each of the above Examples is directed to a normally cooked rice, a steamed glutinous rice, a cooked rice with increased water added for cooking, and a vinegared rice. However, a rice is not restricted to these types of rice, and may be any processed cooked rice.

1. A cooked rice quality improver composition comprising an α-amylase and/or a glucosyltransferase, and a pectinase.

2. The cooked rice quality improver composition according to claim 1, wherein said α-amylase is an endo-type enzyme.

3. The cooked rice quality improver composition according to claim 1, wherein said glucosyltransferase has a 4-α-glucanotransferase activity.

4. The cooked rice quality improver composition according to claim 1, wherein said pectinase has a pectin methylesterase activity.

5. The cooked rice quality improver composition according to claim 4, wherein said pectinase is substantially free of a polygalacturonase activity and a pectin lyase activity.

6. The cooked rice quality improver according to claim 1, wherein said pectinase has a pectintranseliminase activity.

7. A cooked rice manufactured using the cooked rice quality improver composition according to claim 5.

8. A cooked rice manufactured using the cooked rice quality improver composition according to claim 6.

9. A method for manufacturing cooked rice, comprising:
interacting a composition, which includes an α-amylase and/or a glucosyltransferase in combination with a pectinase, with raw rice during rice processing steps, the processing steps including one or more of immersing, cooking, and steaming.

10. The method for manufacturing cooked rice according to claim 9, wherein said α-amylase is an endo-type enzyme.

11. The method for manufacturing cooked rice according to claim 9, wherein said glucosyltransferase has a 4-α-glucanotransferase activity.

12. The method for manufacturing cooked rice according to claim 9, wherein said pectinase has a pectin methylesterase activity.

13. The method for manufacturing cooked rice according to claim 12, wherein said pectinase is substantially free of a polygalacturonase activity and a pectin lyase activity.

14. The method for manufacturing cooked rice according to claim 9, wherein said pectinase has a pectintranseliminase activity.
